(19) United States
(12) Patent Application Publication
(10) Pub. No.: US 2011/0311046 A1
(43) Pub. Date: Dec. 22, 2011

(54) Image Forming System, Image Forming Apparatus, and Method in which an Application is Added

(75) Inventor: Yosuke Oka, Osaka (JP)

(73) Assignee: KYOCERA MITA CORPORATION, Osaka (JP)

(21) Appl. No.: 13/155,928

(22) Filed: Jun. 8, 2011

(30) Foreign Application Priority Data
Jun. 21, 2010 (JP) 2010-140452

(51) Int. Cl. H04N 1/44

(52) U.S. Cl. 380/243

(57) ABSTRACT

An image forming system includes a first computer, a second computer, and an image forming apparatus. The first computer is configured to provide an application file to a first special hash function and generate a first special hash value corresponding to an input first parameter value. The second computer is configured to generate an installation package file including the application file and the first special hash value. The image forming apparatus is configured to provide the application file to a second special hash function that is the same as the first special hash function, generate a second special hash value corresponding to a second parameter value that is stored in the image forming apparatus and that is the same as the first parameter value, and perform a specified process to the application file if the first special hash value matches the second special hash value.

### INCORPORATION BY REFERENCE

This application is based upon, and claims the benefit of priority from, corresponding Japanese Patent Application No. 2010-140452, filed in the Japan Patent Office on Jun. 21, 2010, the entire contents of which is incorporated herein by reference.

### BACKGROUND 1. Field

The present invention relates to an image forming system, an image forming apparatus, and a method in which an application is added by using a special hash value generated by execution of a special hash function.

2. Description of the Related Art

A multifunction peripheral (MFP) can be implemented by downloading an application from an application vendor's server via a network and installing the application in the image forming apparatus.

In the server, a hash value of the application is generated, and the application is distributed with the hash value used as an electronic signature. The following technology is disclosed in order to ensure safety of the application at the time of distribution and to prevent the application from being tampered with.

The distributed application includes an application file and an information file that are encrypted. The application file is encrypted by a system using a common key. The common key used for decrypting the encrypted application file is included in the information file. The information file is encrypted by a secret key. The encrypted information file is decrypted by using a public key paired with the secret key. A recipient of the application file decrypts the application file by extracting the common key from information included in the information file. According to this technology, a distributor of the application can distribute the application only to authorized recipients provided with the public key paired with the secret key.

In addition, the distributed application includes an encrypted digest file. The digest file includes a hash value unique to the distributed application, and is encrypted by the secret key. The encrypted digest file is decrypted by using the public key paired with the secret key. The recipient of the application compares the hash value included in the digest file and the hash value included in the decrypted application file with each other. According to this technology, the recipient of the application can verify whether or not the application file has been tampered by comparing the two hash values with each other.

However, the above-described technology cannot ensure the safety if an application vendor with a malicious intent distributes the application. Further, if the application is tampered after the application is installed in the image forming apparatus, it is impossible to detect the tampering.

### SUMMARY

The present disclosure relates to an image forming system, an image forming apparatus, and a method in which an application is safely added to the image forming apparatus after placement of the image forming apparatus.

An image forming system according to an aspect of the present disclosure includes a first computer, a second computer, and an image forming apparatus. The first computer is configured to provide an application file to a first special hash function, execute the first special hash function, and generate a first special hash value of the application file corresponding to an input first parameter value. The second computer is configured to generate an installation package file that includes the application file and the first special hash value. The image forming apparatus is configured to provide the application file in the installation package file to a second special hash function that is the same as the first special hash function, execute the second special hash function, generate a second special hash value of the application file corresponding to a second parameter value that is stored in the image forming apparatus and that is the same as the first parameter value, and perform a specified process to the application file if the first special hash value matches the second special hash value.

An image forming apparatus according to an aspect of the present disclosure includes a hash value generation unit, an authentication unit, and an added application execution control unit. The hash value generation unit is configured to cause a special hash function to generate a second special hash value of an application file in an installation package file that includes a first special hash value of the application file. The authentication unit is configured to determine whether or not the first special hash value matches the second special hash value. The added application execution control unit is configured to perform a specified process to the application file if the authentication unit determines that the first special hash value matches the second special hash value.

A method in which an application is added, according to the present disclosure includes: providing, via a first computer, an application file to a first special hash function, executing the first special hash function, and generating a first special hash value of the application file corresponding to an input first parameter value; generating, via a second computer, an installation package file that includes the application file and the first special hash value; and providing, via an image forming apparatus, the application file in the installation package file to a second special hash function that is the same as the first special hash function, executing the second special hash function, generating a second special hash value of the application file corresponding to a second parameter value that is stored in the image forming apparatus and that is the same as the first parameter value, and performing a specified process to the application file if the first special hash value matches the second special hash value.

Additional features and advantages are described herein, and will be apparent from the following detailed description and the figures.

### BRIEF DESCRIPTION OF THE FIGURES

In the accompanying drawings:

FIG. 1 shows a block diagram illustrating a hardware configuration of an image forming system according to an embodiment of the present disclosure;

FIG. 2 shows a sequence diagram illustrating communications performed in the image forming system;

FIG. 3 shows a block diagram illustrating a functional configuration of a computer provided to an image forming apparatus manufacturer;

FIG. 4A shows a block diagram illustrating a first example of a configuration of a special hash function;

FIG. 4B shows a block diagram illustrating a second example of a configuration of the special hash function;

FIG. 4C shows a block diagram illustrating a third example of a configuration of the special hash function;

FIG. 5 shows a block diagram illustrating a functional configuration of a computer provided to an application vendor;

FIG. 6A shows a block diagram illustrating a functional configuration related to installation of an application performed in an image forming apparatus; and

FIG. 6B shows a block diagram illustrating a functional configuration related to execution of the application performed in the image forming apparatus.

### DETAILED DESCRIPTION

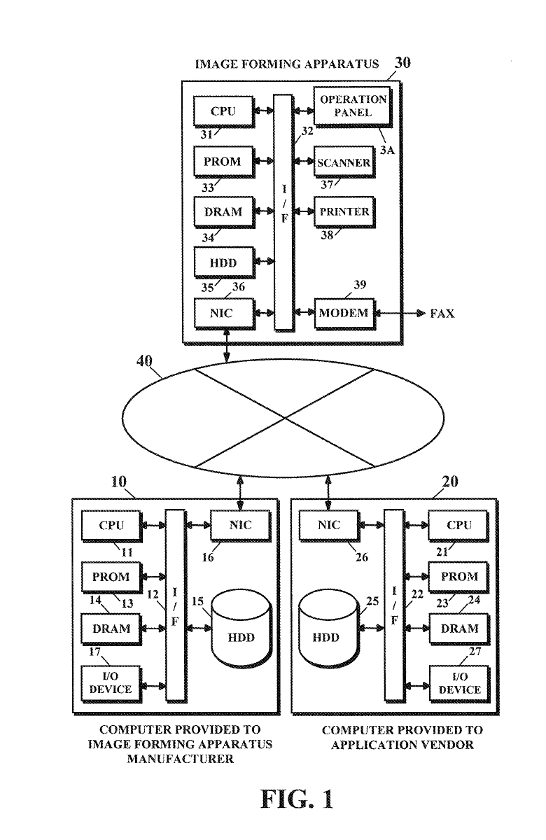

FIG. 1 shows a block diagram illustrating a hardware configuration of an image forming system according to an embodiment of the present disclosure. The image forming system includes a computer 10 of a manufacturer of an image forming apparatus 30, a computer 20 of an application vendor that develops an application of the image forming apparatus 30 and provides the application to a user of the image forming apparatus 30, and the image forming apparatus 30 of the user, which are connected via a network 40. The computer 10 as a server and the computer 20 as a client perform communications with each other. The computer 20 as the server and the image forming apparatus 30 as the client perform communications with each other. The communications between the computers 10 and 20 or between the computer 20 and the image forming apparatus 30 may be encrypted by a secure socket layer (SSL). Further, the communications between the computers 10 and 20 or between the computer 20 and the image forming apparatus 30 may be performed by electronic mail.

In the computer 10, a central processing unit (CPU) 11 is coupled to a programmable read only memory (PROM) 13, a Dynamic Random Access Memory (DRAM) 14, a hard disk drive (HDD) 15, a network interface card (NIC) 16, and an input/output device (I/O device) 17 via an interface (I/F) 12. For the sake of simplicity, one or more kinds of interfaces are represented by one I/F 12.

The PROM 13 is, for example, a flash memory, and stores a basic input/output system (BIOS). The DRAM 14 is used as a main storage device. The HDD 15 stores an operating system (OS) of a virtual storage system, various kinds of drivers and applications, and data. The NIC 16 is coupled to the network 40. The I/O device 17 includes, for example, a keyboard and a pointing device as input devices, and a display.

The computer 20 has a configuration that is the same as or similar to the computer 10, and components of the computer 20 denoted by reference numerals 21 to 27 correspond to the components of the computer 10 denoted by reference numerals 11 to 17, respectively.

In the image forming apparatus 30, a CPU 31 is coupled to a PROM 33, a DRAM 34, a HDD 35, a NIC 36, a scanner 37, a printer 38, a modem 39 for fax, and an operation panel 3A via an I/F 32.

The PROM 33 is, for example, the flash memory, and stores the BIOS, the OS, various kinds of drivers, and various kinds of applications for performing functions of the image forming apparatus. The DRAM 34 is used as the main storage device. In the HDD 35, data for printing, image data read by the scanner 37, and data received by facsimile are stored. The NIC 36 is coupled to the network 40. The scanner 37 is used as an input device for printing and facsimile transmission and also used to create an image file. The printer 38, including a print engine and a sheet feeding unit, transport unit, and delivery unit for paper, is supplied with bitmap data generated in the DRAM 34, forms an electrostatic latent image on a photoconductor drum on the basis of the bitmap data, develops the electrostatic latent image by toner to obtain a toner image, transfers the toner image on the paper, fixes the toner image, and delivers the paper. The operation panel 3A includes keys and a display panel.

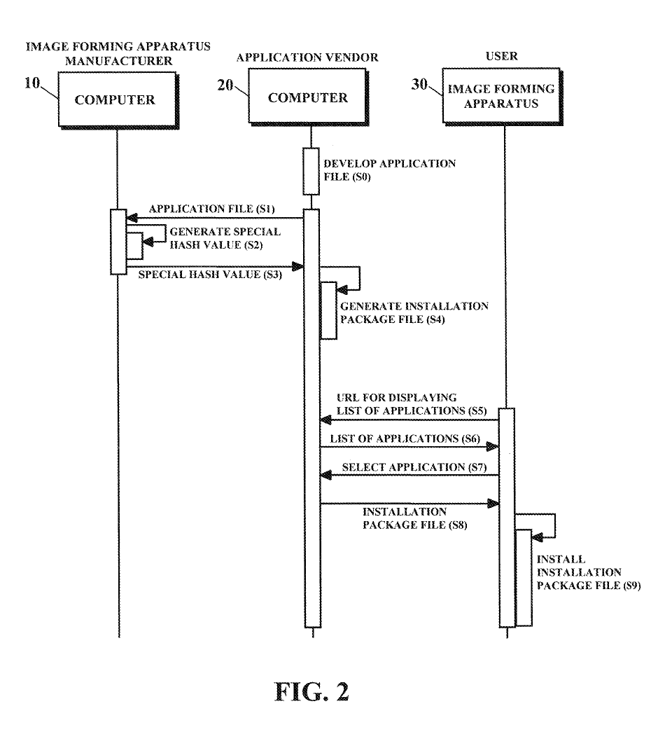

FIG. 2 shows a sequence diagram illustrating communications performed in the image forming system of FIG. 1.

At the application vendor, a developer uses a software development kit (SDK) installed in the computer 20 to develop an application file (S0), affixes an electronic signature to the application file, transmits the application file with an electronic certificate to the computer 10 of the image forming apparatus manufacturer (S1), and sends a request to generate a special hash value of the application file. The application file includes one compressed file by combining a plurality of files, for example, a Java archive (jar) file, which is based on Java (registered trademark).

In response to the request, if the electronic certificate is an authorized one that belongs to the application vendor registered in the computer 10, the computer 10 uses the electronic signature to verify that the application file has not been tampered, and then generates the special hash value of the application file (S2).

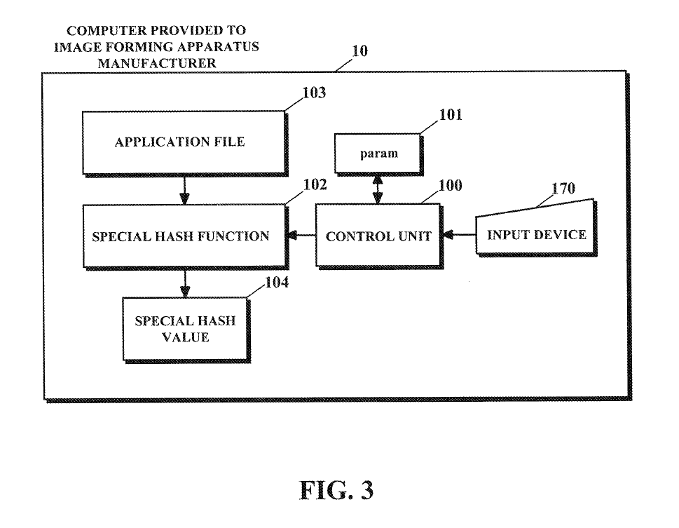

FIG. 3 shows a block diagram illustrating a functional configuration of the computer 10 provided to the image forming apparatus manufacturer.

Via an input device 170 of the I/O device 17, an operator executes a control unit 100 and inputs a secret parameter value. The control unit 100 stores the secret parameter value as a parameter value (“param”) 101 in the HDD 15. If the parameter value 101 stored most recently is used, this input operation is omitted. The application file 103 received from the computer 20 is selected as a processing target of a special hash function 102 by the control unit 100. An instruction to generate a special hash value 104 is provided to the control unit 100.

In response to the instruction, the parameter value 101 and an address of the application file 103 (for example, path to the file and/or address in the memory) are provided as arguments to the special hash function 102 by the control unit 100, and the special hash function 102 is executed. The special hash function 102 generates a special hash value 104 corresponding to the parameter value 101.

Typical normal hash function used for the electronic signature, for example, MD5, SHA-1, or MINMAX, generates the same normal hash value with respect to the same input message (in this embodiment, the application file 103) for each respective hash function. In contrast, the special hash function 102 used in this embodiment generates a new type of hash value that varies corresponding to the parameter value 101 as the special hash value 104.

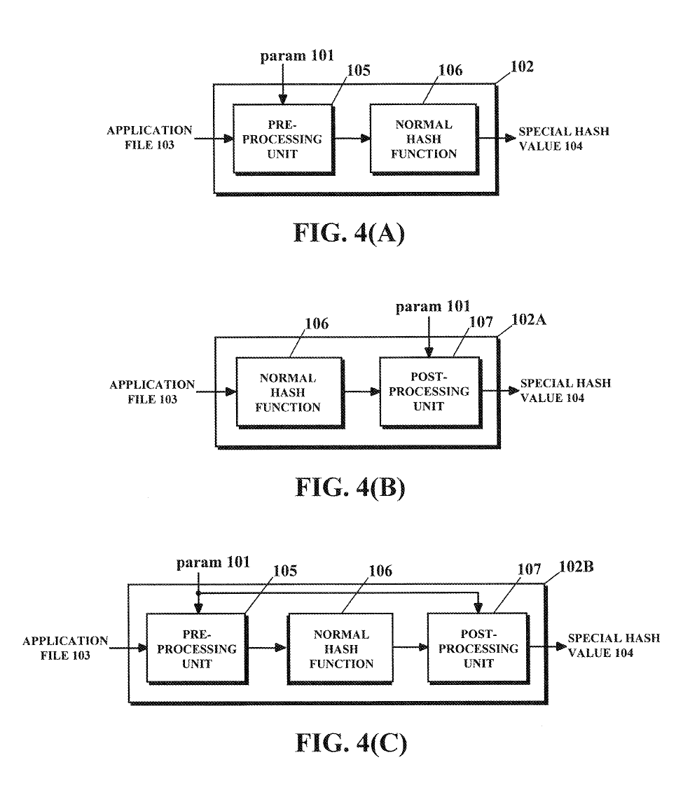

FIG. 4A, FIG. 4B, and FIG. 4C show block diagrams illustrating first, second, and third examples of configurations of the special hash functions, respectively. As illustrated in FIG. 4A, the special hash function 102 as the first example includes, for example, a pre-processing unit 105 that converts the application file 103 corresponding to the parameter value 101 and a normal hash function 106 that generates the normal hash value of the converted application file (accordingly, generates the special hash value 104), in the stated order. Alternatively, as illustrated in FIG. 4B, by reversing the combination order of the pre-processing unit 105 and the normal hash function 106 that are illustrated in FIG. 4A, the special hash function 102A as the second example includes the normal hash function 106 that generates the normal hash value and a post-processing unit 107 that converts the normal hash value corresponding to the parameter value 101 and generates the special hash value 104, in the stated order. In this case, the post-processing unit 107 may be an encryption unit that encrypts the normal hash value by using a password as the parameter value 101 and generates the special hash value 104. In addition, as illustrated in FIG. 4C, by combining the configurations of FIG. 4A and FIG. 4B, the special hash function 102B as the third example includes the pre-processing unit 105 that converts the application file 103 corresponding to the parameter value 101, the normal hash function 106 that generates the normal hash value of the converted application file, and the post-processing unit 107 that converts the normal hash value of the converted application file corresponding to the parameter value 101 and generates the special hash value 104, in the stated order. In this case, same or different parameter values 101 may be supplied to the pre-processing unit 105 and the post-processing unit 107.

In FIG. 2, the control unit 100 affixes an electronic signature to the special hash value 104, attaches an electronic certificate, and transmits the special hash value 104 to the computer 20 of the application vendor via the network 40 (S3).

If the electronic certificate is an authorized one that belongs to the image forming apparatus manufacturer registered in the computer 20 in advance, the computer 20 uses the electronic signature to verify that the special hash value 104 has not been tampered with, and then generates an installation package file for the application file 103 (S4).

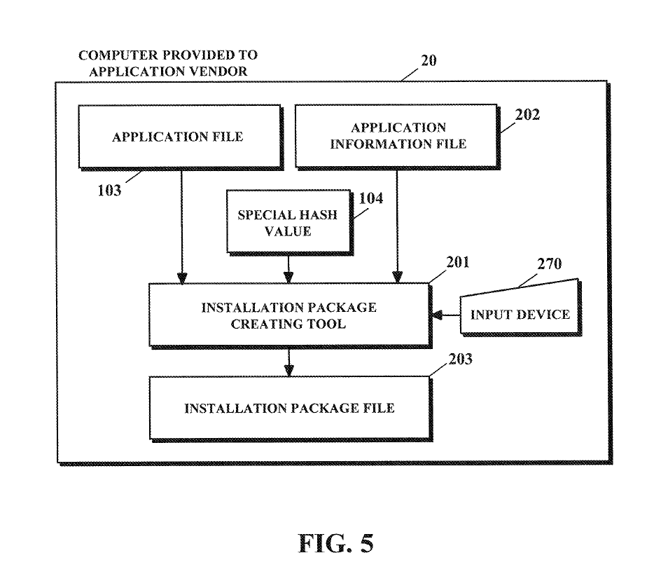

FIG. 5 shows a block diagram illustrating a functional configuration of the computer 20 provided to the application vendor.

When an installation package creating tool 201 is executed by the operator via an input device 270 of the I/O device 27, a screen that receives an input of application information is displayed on the display of the I/O device 27. The application information includes meta-information on the application file 103. The meta-information includes, for example, information (for example, a file name) that specifies a file including a main routine to be executed first among the plurality of files.

The file name of the specified file including the main routine is input to the installation package creating tool 201 by the operator via the input device 270. Subsequently, the application file 103 and the special hash value 104 are specified, and then an instruction to create the installation package file 203 is performed.

The installation package creating tool 201 acquires respective pieces of version information on the plurality of jar files compressed in the application file 103. The version information is also included in the application information. The installation package creating tool 201 creates an application information file 202 including the application information and creates a folder. Then, the installation package creating tool 201 stores the application file 103, the application information file 202, and the special hash value 104 into the created folder, and creates one compressed installation package file 203 by combining the folder and all the files.

In FIG. 2, a browser is executed by the user operating the image forming apparatus 30 and is provided with a URL of the computer 20 (URL for displaying a list of applications) (S5), and contents of an HTML file acquired from the computer 20 are displayed on the browser (S6). The display on the browser includes the list of the applications developed by the application vendor and descriptions for the applications, and the desired application is selected by the user (S7).

The browser of the image forming apparatus 30 requests the installation package file 203 from the computer 20, and the computer 20 transmits the installation package file 203 to the image forming apparatus 30 (S8). The image forming apparatus 30 receives the installation package file 203, and in response to the instruction via the operation panel 3A, installs the received installation package file 203 in the HDD 35 (S9).

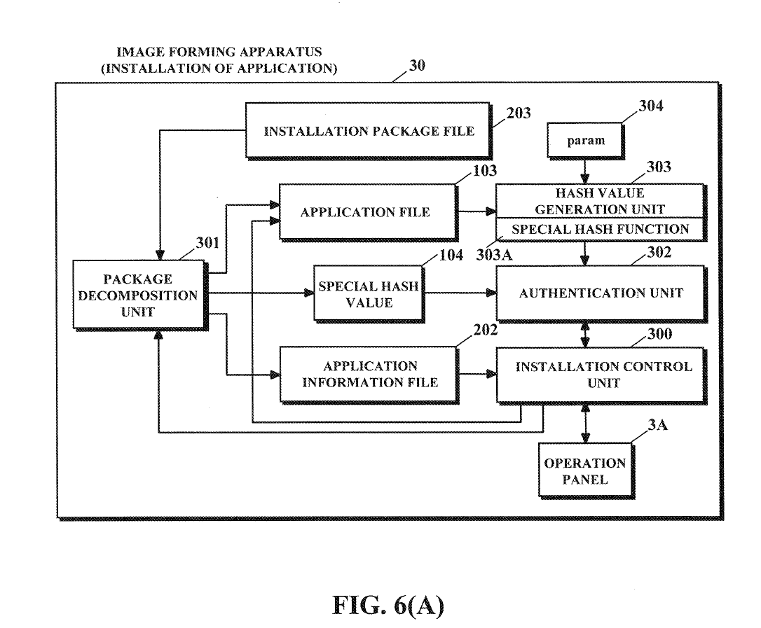

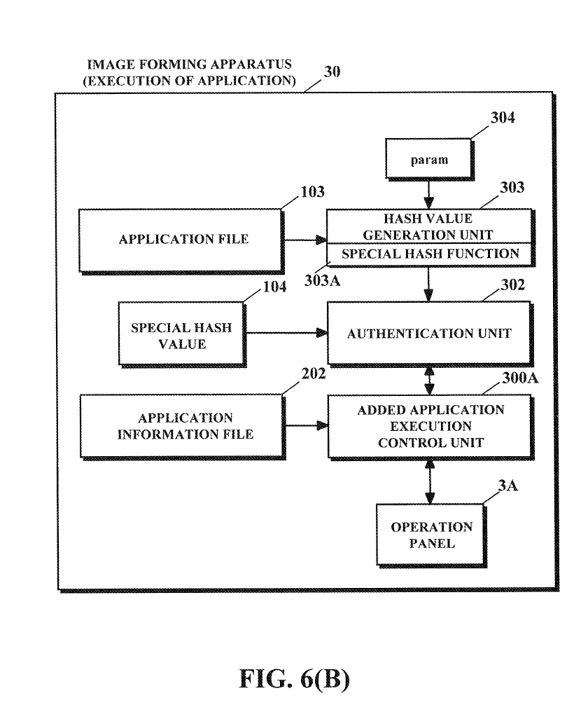

FIG. 6A shows a block diagram illustrating a functional configuration related to installation of an application performed in the image forming apparatus 30.

An installation control unit 300 is executed by the user via the operation panel 3A, and an execution instruction is provided to the specified installation package file 203.

The installation control unit 300 provides the address of the installation package file 203 as an argument to a package decomposition unit 301, and executes the package decomposition unit 301. The package decomposition unit 301 decompresses the installation package file 203, decomposes the installation package file 203 into its components (the application file 103, the special hash value 104, and the application information file 202), and deletes the installation package file 203. Accordingly, the special hash value 104 and the application information file 202 are decompressed.

When the above-described process of the package decomposition unit 301 is finished, the installation control unit 300 provides the addresses of the application file 103 as arguments, and the special hash value 104, to an authentication unit 302, and executes the authentication unit 302.

The authentication unit 302 provides, as arguments to a special hash function 303A, a parameter value 304 and the address of the application file 103, and executes the special hash function 303A. The parameter value 304 is the same value as the parameter value 101 of FIG. 3 and is stored in advance in the image forming apparatus 30. The special hash function 303A is the same function as the special hash function 102 of FIG. 3. A hash value generation unit 303 causes the special hash function 303A to generate the special hash value of the application file 103 corresponding to the parameter value 304, and provides the generated special hash value to the authentication unit 302 as a return value.

The authentication unit 302 compares the generated special hash value with the special hash value 104, and provides the result (whether or not these special hash values match each other) to the installation control unit 300 as the return value. The installation control unit 300 causes the contents of the result to be displayed on the operation panel 3A. If the result indicates that these special hash values do not match each other, the installation control unit 300 further causes an inquiry to be displayed on the operation panel 3A as to whether or not to delete the application file 103, and in response to a user instruction to delete the application file 103, deletes the application file 103, the special hash value 104, and the application information file 202.

FIG. 6B shows a block diagram illustrating a functional configuration related to execution of the application performed in the image forming apparatus 30.

An added application execution control unit 300A is executed by the user via the operation panel 3A, and the application file to be executed is specified. Then, an added application execution instruction is provided to the added application execution control unit 300A.

The added application execution control unit 300A provides the address of the application file 103 and the special hash value 104 as arguments to the authentication unit 302 and executes the authentication unit 302.

The authentication unit 302 provides the parameter value 304 and the address of the application file 103 as arguments to the special hash function 303A and executes the special hash function 303A.

The hash value generation unit 303 causes the special hash function 303A to generate the special hash value of the application file 103 corresponding to the parameter value 304, and provides the generated special hash value to the authentication unit 302 as the return value. The authentication unit 302 compares the generated special hash value with the special hash value 104, and provides the result (whether or not these special hash values match each other) to the added application execution control unit 300A as the return value.

The added application execution control unit 300A causes the contents of the result to be displayed on the operation panel 3A. If the result indicates that these special hash values do not match each other, the added application execution control unit 300A further causes the inquiry to be displayed on the operation panel 3A as to whether or not to delete the application file 103, and in response to the user instruction to delete the application file 103, deletes the application file 103, the special hash value 104, and the application information file 202. If the result indicates that these special hash values match each other, in response to the user instruction to install the application file 103, the added application execution control unit 300A decompresses the application file 103 in the memory, and executes the main routine within the file name indicated by the installation package file 203.

Accordingly, with the above-described configuration, the parameter values 101 and 304 provided to the special hash functions 102 and 303A are not known by the application vendor that generates an installation package file. Then, it is possible to verify whether or not the application file 103 to be used in the image forming apparatus 30 is authorized on the basis of the special hash value of the application file 103 generated by the special hash function 102 in the computer 10 provided to the image forming apparatus manufacturer. Therefore, if the application vendor distributes the application without using the special hash function 102 or the parameter value 101, or if the user tampers with the application after the installation of the application, this can be detected and eliminated, which can improve the safety of the execution of the application.

The present disclosure of the embodiment includes various other embodiments. For example, other designs may be used in which the above-described components are each performed.

For example, the computer 10 is not limited to the one that is provided to the image forming apparatus manufacturer, and may include a computer of a company or the like commissioned by the image forming apparatus manufacturer. In the same manner, the computer 20 is not limited to the one that is provided to the application vendor, and may include a computer of a company or the like commissioned by the application vendor.

For example, the application file 103 is not limited to include one compressed file, and may include one file specified by the application information file 202. In addition, by using the special hash value 104 of each of the plurality of files included in the application file 103, the authentication unit 302 may verify the respective files.

In addition, at a stage of activation of the application performed between the installation of the application illustrated in FIG. 6A and the first execution of the application illustrated in FIG. 6B, the authentication using the special hash value may be performed in the same manner of this embodiment prior to the activation of the application. In this case, information indicating whether or not the application has been activated is located outside the application file 103. Then, the information is excluded from the input message and the same special hash values of the application file 103 are generated before and after the activation.

The authentication using the special hash value according to the present disclosure may be executed in at least one of the process for installing the application file in the image forming apparatus, the process for activating the application file, and the process for executing the application file.

Further, in FIG. 4A, FIG. 4B, and FIG. 4C, without using the pre-processing unit 105 or the post-processing unit 107, the special hash function 102 may use random numbers, and seeds of the random numbers may be set as the parameter values 101 and 304.

Further, for example, the parameters 101 and 304 may be configured to be stored in another chip protected by typical encryption.

It should be understood that various changes and modifications to the embodiments described herein will be apparent to those skilled in the art. Such changes and modifications may be made without departing from the spirit and scope of the present subject matter and without diminishing its intended advantages. It is therefore intended that such changes and modifications be covered by the appended claims.

What is claimed is:

1. An image forming system, comprising:
a first computer configured to provide an application file to a first special hash function, execute the first special hash function, and generate a first special hash value of the application file corresponding to an input first parameter value;
a second computer configured to generate an installation package file that includes the application file and the first special hash value; and
an image forming apparatus configured to provide the application file in the installation package file to a second special hash function that is the same as the first special hash function, execute the second special hash function, generate a second special hash value of the application file corresponding to a second parameter value that is stored in the image forming apparatus and that is the same as the first parameter value, and perform a specified process to the application file if the first special hash value matches the second special hash value.

2. The image forming system according to claim 1,
wherein the first computer is provided to a manufacturer of the image forming apparatus; and
wherein the second computer is provided to an application vendor of the application file.

3. The image forming system according to claim 1,
wherein the specified process to the application file includes at least one of a process for installing the application file in the image forming apparatus, a process for activating the application file, and a process for executing the application file.

4. The image forming system according to claim 1,
wherein the application file is compressed by combining a plurality of files; and
wherein the installation package file includes an application information file that specifies a file including a main routine to be executed first among the plurality of files.

5. The image forming system according to claim 4,
wherein the image forming apparatus is further configured to decompress the installation package file into the application file, the application information file, and the first special hash value, decompress the application file into the plurality of files, and execute the main routine.

6. The image forming system according to claim 1, wherein at least one of the first and the second special hash functions comprises:
a pre-processing unit configured to convert the application file corresponding to at least one of the first and the second parameter values; and
a normal hash function configured to generate at least one of the first and the second special hash values of the converted application file.

7. The image forming system according to claim 1, wherein at least one of the first and the second special hash functions comprises:
a normal hash function configured to generate a hash value of the application file; and
a post-processing unit configured to convert the hash value corresponding to at least one of the first and the second parameter values and generate at least one of the first and the second special hash values.

8. The image forming system according to claim 1, wherein at least one of the first and the second special hash functions comprises:
a pre-processing unit configured to convert the application file corresponding to at least one of the first and the second parameter values;
a normal hash function configured to generate a hash value of the converted application file; and
a post-processing unit configured to convert the hash value corresponding to at least one of the first and the second parameter values and generate at least one of the first and the second special hash values.

9. An image forming apparatus, comprising:
a hash value generation unit configured to cause a special hash function to generate a second special hash value of an application file in an installation package file that includes a first special hash value of the application file;
a authentication unit configured to determine whether or not the first special hash value matches the second special hash value; and
an added application execution control unit configured to perform a specified process to the application file if the authentication unit determines that the first special hash value matches the second special hash value.

10. The image forming apparatus according to claim 9,
wherein the specified process to the application file includes at least one of a process for installing the application file in the image forming apparatus, a process for activating the application file, and a process for executing the application file.

11. The image forming apparatus according to claim 9,
wherein the application file is compressed by combining a plurality of files; and
wherein the installation package file further includes an application information file that specifies a file including a main routine to be executed first among the plurality of files.

12. The image forming apparatus according to claim 11, further comprising a package decomposition unit configured to decompress the installation package file into the application file, the application information file, and the first special hash value,
wherein the added application execution control unit is further configured to decompress the application file into the plurality of files and execute the main routine.

13. A method in which an application is added, comprising:
providing, via a first computer, an application file to a first special hash function, executing the first special hash function, and generating a first special hash value of the application file corresponding to an input first parameter value;
generating, via a second computer, an installation package file that includes the application file and the first special hash value; and
providing, via an image forming apparatus, the application file in the installation package file to a second special hash function that is the same as the first special hash function, executing the second special hash function, generating a second special hash value of the application file corresponding to a second parameter value that is stored in the image forming apparatus and that is the same as the first parameter value, and performing a specified process to the application file if the first special hash value matches the second special hash value.

14. The method in which an application is added according to claim 13,
wherein the first computer is provided to a manufacturer of the image forming apparatus; and
wherein the second computer is provided to an application vendor of the application file.

15. The method in which an application is added according to claim 13,
wherein the specified process to the application file includes at least one of a process for installing the application file in the image forming apparatus, a process for activating the application file, and a process for executing the application file.

16. The method in which an application is added according to claim 13, further comprising:
compressing, via the second computer, the application file by combining a plurality of files, and generating the installation package file including an application information file that specifies a file including a main routine to be executed first among the plurality of files.

17. The method in which an application is added according to claim 16, further comprising:
decompressing, via the image forming apparatus, the installation package file into the application file, the application information file, and the first special hash value, decompressing the application file into the plurality of files, and executing the main routine.

18. The method in which an application is added according to claim 13, further comprising:
performing a second specified process to the application file if the first special hash value does not match the second special hash value.

19. The method in which an application is added according to claim 18,
wherein the second specified process includes displaying an inquiry as to whether or not to delete the application file.

20. The method in which an application is added according to claim 19, further comprising:
deleting the application file, deleting the special hash value, and deleting the application information file in response to a user instruction.
